(19) United States
(12) Patent Application Publication
(10) Pub. No.: US 2017/0185345 A1
(43) Pub. Date: Jun. 29, 2017

(54) SYSTEM-ON-CHIP INCUDING ACCESS CONTROL UNIT AND MOBILE DEVICE INCLUDING SYSTEM-ON-CHIP

(71) Applicant: SAMSUNG ELECTRONICS CO., LTD., Suwon-si (KR)

(72) Inventors: MINSOO LIM, HWASEONG-SI (KR); SANGYUN HWANG, SUWON-SI (KR); WOOHYUNG CHUN, YONGIN-SI (KR); SIK KIM, SEOUL (KR)

(21) Appl. No.: 15/345,572

(22) Filed: Nov. 8, 2016

(30) Foreign Application Priority Data
Dec. 28, 2015 (KR) 10-2015-0187774

(51) Int. Cl. G06F 3/06; G06F 13/16; G06F 13/40; G06F 12/10

(52) U.S. Cl. CPC G06F 3/0637; G06F 3/0622; G06F 3/0679; G06F 12/10; G06F 13/1668; G06F 13/4068; G06F 2212/65

(57) ABSTRACT

A System-on-Chip (SoC) includes a communication processor, an application processor that sets a secure mode of the communication processor through a control bus, and an access control unit that sets or changes an access control of the communication processor, based on an address region and an access permission of the communication processor. The SoC performs access control operations of respective hardware blocks, through an access control unit. When various systems are integrated in one system-on-chip, an access control operation is performed according to the secure attributes and access permissions of the systems.

### CROSS-REFERENCE TO RELATED APPLICATIONS

A claim for priority under 35 U.S.C. §119 is made to Korean Patent Application No. 10-2015-0187774 filed on Dec. 28, 2015 in the Korean Intellectual Property Office, the subject matter of which is hereby incorporated by reference.

### BACKGROUND

The inventive concept relates to an electronic device, and more particularly to a system-on-chip (SoC) including an access control unit, as well as an operating method thereof.

Mobile devices such as smartphones or tablet PCs providing a multitude of functions are increasingly popular consumer products. Application programs capable of processing different forms of content are common run on mobile devices. Among other forms of content, various security content are typically run to inhibit access to mobile device resources by unauthorized entities. Security technologies applied to mobile devices and related systems include software and/or hardware aspects.

Mobile device hardware aspects, as well as associated operating system(s) and programming code are relatively vulnerable and may be used to attack various security contents. The security technologies and methodologies used by contemporary mobile devices may be said to define, modify, authorize and/or administer and set of permissions (e.g., functions, requirements, etc.) sometimes referred to as digital rights management (DRM). The implementation of DRM is compulsory in most mobile devices. In order to properly enforce core requirements associated with DRM, particular aspects of the hardware and/or software associated with a mobile device should be protected from unauthorized access or manipulation.

One contemporary approach to the definition, use and/or administration of DRM has been proposed by ARM®, Inc. and is referred to as TrustZone®. However, limitations and vulnerabilities related to TrustZone have been noted in various Central Processing Unit (CPU) and/or SoC environments. For example, certain TrustZone functions and features that work well with one CPU/SoC configuration may struggle with another CPU/SoC configuration. This is particularly true in certain configurations where the CPU and SoC are implemented and/or provided by different vendors.

### SUMMARY

Embodiments of the inventive concept provide systems including a System-on-Chip (SoC) that cope with various requirements when various systems are integrated within the SoC.

Certain embodiments of the inventive concept provides a system including; a System-on-Chip (SoC) including a hardware block configured between a control bus and a data bus, a processing unit configured to set the hardware block in one of a secure mode and a non-secure mode via the control bus, and an access control unit configured to control access by the hardware block to memory resources via the data bus based on an address region. The memory resources include an internal memory, an external working memory and a storage device. The address region indicates a memory region of one of the memory resources.

Certain embodiments of the inventive concept provide a System-on-Chip (SoC) configured to operate with an external working memory and a storage device. The SoC includes an internal memory, a plurality of masters including an application processor (AP) and a communication processor (CP) connected via a bus to a plurality of slaves, and an access control unit that controls access to the internal memory, working memory and storage device by at least one of the masters. Each master is capable of operating in a secure mode and a non-secure mode as determined by the AP. The bus includes a control bus and a data bus, and the CP is disposed between the control bus and the data bus. The access control unit is functionally disposed between the CP and the internal memory, the working memory and the storage device.

Certain embodiments of the inventive concept provide a mobile device including; a System-on-Chip (SoC) comprising a plurality of processors and a memory device connected to the SoC. The SoC includes an access control unit that comprises first and second processors, the first processor setting a secure mode of the second processor via a control bus and setting an access control of the second processor based on an address region and an access permission of the second processor.

### BRIEF DESCRIPTION OF THE DRAWINGS

The above and other objects and features will become apparent from the following description with reference to the following figures, wherein like reference numerals refer to like parts throughout the various figures unless otherwise specified, and wherein

FIG. 1 is a block diagram schematically illustrating a mobile device including a system-on-chip (SoC);

FIG. 2 is a block diagram exemplarily illustrating internal resources of the system-on-chip of FIG. 1;

FIG. 3 is a block diagram illustrating a mobile device according to an embodiment of the inventive concept;

FIG. 4 is a block diagram illustrating an access control method of the system-on-chip (SoC) of FIG. 3;

FIG. 5 is a concept view exemplarily illustrating the access control method of the system-on-chip of FIG. 3;

FIG. 6 is a concept view exemplarily illustrating another embodiment of the access control method of the system-on-chip of FIG. 3;

FIG. 7 is a block diagram illustrating a mobile device according to another embodiment of the inventive concept;

FIG. 8 is a block diagram illustrating the access control method of the system-on-chip of FIG. 7;

FIG. 9 is a block diagram exemplarily illustrating the access control unit of FIGS. 7 and 8;

FIG. 10 is a concept view illustrating an operating method of the access control unit 240 of FIG. 9;

FIG. 11 is a concept view exemplarily illustrating the operating method of the access control unit 240 of FIG. 9;

FIG. 12 is a flowchart illustrating an access control operation of the mobile device of FIG. 7; and

FIG. 13 is a block diagram illustrating a mobile device including the system-on-chip according to the embodiment of the inventive concept.

### DETAILED DESCRIPTION

Certain embodiments of the inventive concept including a system-on-chip (SoC) will be described. However, those skilled in the art will understand various advantages and performances of the inventive concept upon contemplation of the following written description taken together with the accompanying drawings. Those skilled in the art will also understand that the inventive concept may be implemented according to other embodiments. Moreover, the illustrated embodiments set forth herein may be variously modified without departing from the scope of the inventive concept as defined by the following claims.

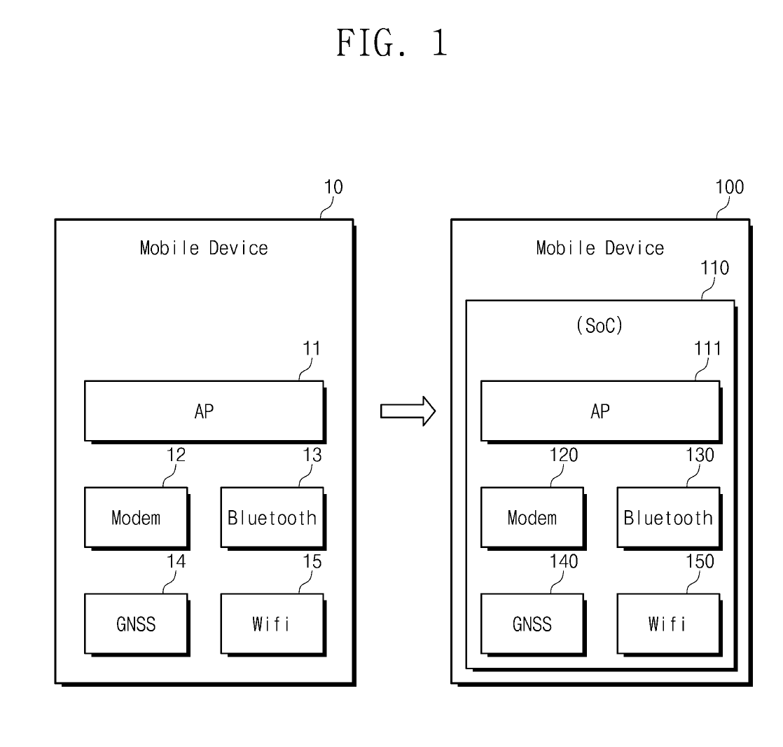

Figure (FIG. 1 is a block diagram illustrating the ongoing design migration from a mobile device 10 including separate chips to a mobile device 100 including a system-on-chip (SoC) that variously integrates the functionality and circuitry previously provided by the separate chips. Of course, the illustrated example of FIG. 1 is just a selected example of certain functional blocks, however previously implemented, that may be integrated using emerging SoC technologies.

Thus, the mobile device 10 includes an application processor 11, a modem 12, a Bluetooth system 13, a global navigation satellite system (GNSS) 14, and a Wi-Fi system 15, as examples of many other functional blocks that may be used in various embodiments of the inventive concept. Although these functional blocks (or “systems”) may share certain resources and possibly even some circuitry, they are generally understood as having previously been provided by separate chips. However, with the development and refinement of SoC technologies, multiple systems that were once provided by separate chip in mobile device 10 have been merged (or “integrated”) into a single SoC 110. Here, the SoC 110 includes an application processor (AP), a modem 120, a Bluetooth system 130, a GNSS 140, and a Wi-Fi system 150.

The mobile device 100 will also include various internal resources (e.g., one or more internal memories, registers, etc.) necessary to the operation of the multiple systems. An external memory or storage device (not shown in FIG. 1) may be configured from a Dynamic Random Access Memory (DRAM) and/or a non-volatile memory (e.g., flash memory) and provided as an external resource to the SoC 110.

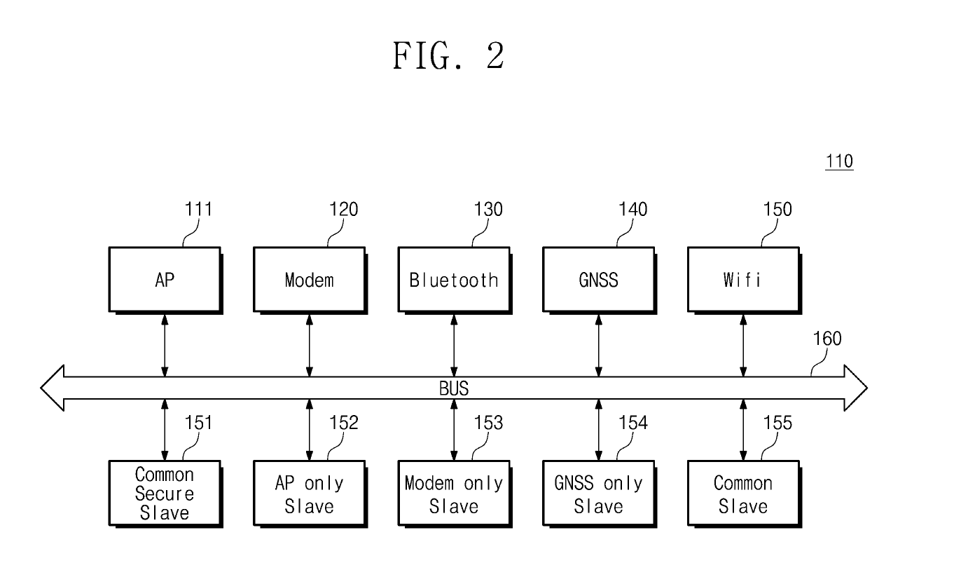

FIG. 2 is a block diagram illustrating certain internal resources that may be provided by the SoC 110 of FIG. 1. The SoC 110 includes certain hardware blocks such as an application processor (AP) 111, modem 120, Bluetooth system 130, GNSS 140, and Wi-Fi system 150. One or more of the hardware blocks may be operated in the SoC 110 as a master.

Various slaves operating in response to (or under the control of) a master may be provided among the hardware blocks of the SoC 110. Various masters and/or slaves may be connected via a bus 160. As will be seen hereafter, the bus 160 may be implemented in many an different forms including (e.g.,) one or more data bus(es) and/or control bus(es). Examples of different slaves that may be included among the hardware blocks of the SoC 110 of FIG. 2 include; a common secure slave 151, an AP only slave 152, a modem only slave 153, a GNSS only slave 154, and a common slave 155.

Each one of these hardware blocks (master and/or slave) in FIG. 2 may be configured to operate according to one or more security property (or “access permission”). In certain hardware blocks, the use (or non-use) of a defined access permission may be established (or “set”) according to the selection of a secure mode (or non-secure mode). For example, a first master may be able to select (or access) a first slave when it is running in a non-secure mode, but may be unable to access the first slave when it is running in a secure mode. Additionally or alternatively, the secure mode versus non-secure mode of the first master may control access to the first slave by the first master. Alternatively, the conditions (or limitations) of access for the first master in relation to the first slave may vary between the selection of a secure mode versus a non-secure mode for the first master and/or first slave.

In certain embodiments of the inventive concept, an authorized secure master may access any slave, whether the slave is running in a secure mode or a non-secure mode. Thus, in the illustrated example of FIG. 2, a secure master (e.g., any one of AP 111, modem 120, Bluetooth 130, GNSS 140 and Wi-Fi 150) may access (e.g.,) either the common secure slave 151 or the common slave 155, but a non-secure master may only access the common slave 155.

One or more slaves may be dedicated to the use of a single master. Such dedication of slave use to a master may be absolute (i.e., only a single master may ever access the slave), or conditional (i.e., only when the master is secure, the slave is secure, or both the master and slave are secure).

Thus, in one possible embodiment assuming that the AP only slave 152, modem only slave 153, and GNSS only slave 154 are each set to a non-secure mode, then only the AP 111 may access the AP only slave 152, only the modem 120 may access the modem only slave 153, and only the GNSS 140 may access the GNSS only slave 154.

In the context of the illustrated embodiments of FIGS. 1 and 2, it will be understood that various systems (e.g., AP 111, modem 120, Bluetooth 130, GNSS 140, and Wi-Fi 150) may be integrated within a single SoC 110. As various systems are integrated and inter-operated within a SoC, numerous potential security problems may arise and become increasingly complex. Given the importance of preventing security problems in mobile devices having one or more SoC(s) including multiple systems potentially provided by different vendors, some form of internal resource access control is required.

Thus, in certain embodiments of the inventive concept, access to a hardware block—among a plurality of hardware blocks associated with one or more systems integrated on a SoC—may be controlled by an access control unit. Such access control may be based on an authorized address region. Here, the term “address region” refers to one or more addresses (i.e., memory locations) indicating a memory region of an internal memory (i.e., a memory integrated on the SoC), an external working memory or an external bulk memory of the type conventionally provided by a storage device. In this regard, access control to one or more hardware block(s) associated with a system integrated on the SoC may be accomplished on the basis of a corresponding access region and/or other access permission approaches (e.g., operating mode selection).

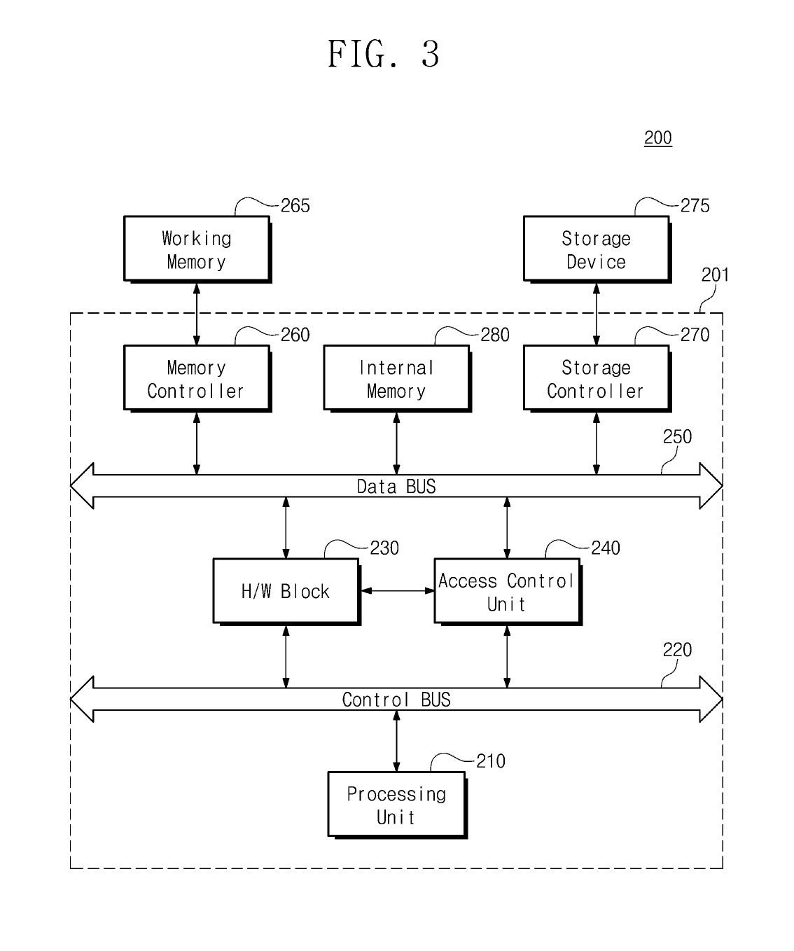

FIG. 3 is a block diagram illustrating a mobile device 200 according to an embodiment of the inventive concept. Referring to FIG. 3, the mobile device 200 includes a SoC 201, a working memory 265, and a storage device 275, where the SoC 201 is configured to perform access control based on address region.

The SoC 201 of FIG. 3 includes; a processing unit 210, a hardware block 230, an access control unit 240, and an internal memory 280. The SoC 201 also includes a memory controller 260 configured to control an external working memory 265, and a storage controller 270 configured to control an external storage device 275. Here, the working memory 265 may be implemented by a random access memory (RAM) such as a DRAM, and the storage device 275 may be implemented by a storage medium such as a memory card based on a flash memory or a USB.

The processing unit 210 of FIG. 3 is assumed to be a central processing unit (CPU) capable of executing various software applications, including at least one operating system (OS). The processing unit 210 is also assumed to be capable of directly driving various hardware blocks, including hardware block 230, (e.g.,) by controlling one or more hardware driver(s).

With this capability, the processing unit 210 may “set” (e.g., define for operation) the hardware block 230 to a secure mode or a non-secure mode. By controlling the memory controller 260, the processing unit 210 may also set one or more address region(s) within the working memory 265 as a secure region or a non-secure region. Similarly, the processing unit 210 may set one or more address region(s) within the external storage device 275 and/or internal memory 280 as a secure region or a non-secure region.

In certain embodiments of the inventive concept, the processing unit 210 may set a secure mode for the hardware block 230 by referencing one or more secure state bit(s). In this regard, a secure mode for the processing unit 210 may be set using a control bus 220 connecting the processing unit 210 with the hardware block 230 and access control unit 240. Thus, the processing unit 210 may control access control to the hardware block 230 using signals or data communicated via the control bus 220.

In the illustrated example of FIG. 3, the hardware block 230 may be a processor or a system, such as the modem 120, GNSS 140, Wi-Fi 150, or Bluetooth 130 of FIG. 2. In this regard, the hardware block 230 may operate within the SoC 201 as a master, may include one or more slaves necessary to the operation of the master, and/or may be operated in a secure mode and a non-secure mode.

In many embodiments, the hardware block 230 will have data processing capabilities necessary to receive, process, modify, reproduce and provide various content. In one example, the hardware block 230 may a CODEC capable of decoding compressed data content in order to provide corresponding video and/or audio signals. In another example, the hardware block 230 may be an image converter capable of converting one data format and/or size associated with an image into another data format and/or size suitable for the mobile device.

The access control unit 240 of FIG. 3 may be used to define or modify an address region that controls access to a system memory resource (e.g., internal memory 280, working memory 265 and/or storage device 275) by the hardware block 230. In certain embodiments of the inventive concept the access control unit 240 is “functionally disposed” between the hardware block(s) 230 (e.g., a communication processor or modem) and the system memory resources. In this regard, the access control unit 240 may manage (or control) access to a given region of the system memory resources (e.g., secure or non-secure address regions) in response to (or based on) a provided address region. In certain embodiments, the access control unit 240 may include an address mapping table to which an address region accessible by the hardware block 230 operating in a secure mode may be mapped. Entry to and exit from the secure mode may be controlled by operation of a secure operating system such that the access control unit 240 allows/disallows access by the hardware block 230 to one or more system memory resources.

The access control unit 240 may set one or more secure attribute(s) of the hardware block 230, external working memory 265, storage device 275, and/or internal memory 280 under the control of the processing unit 210. For example, assuming that the access control unit 240 functions in a manner consistent with the specifications associated with TrustZone, it may manage various secure attributes for one or more hardware blocks according to a secure mode and a non-secure mode.

In the illustrated embodiment of FIG. 3, the data bus 250 provides a portion of an access path between the processing unit 210 or hardware block 230 to the external working memory 265. Thus, in order to securely process content, the hardware block 230 may fetch data from the working memory 265 via the memory controller 260 and data bus 250, process the fetched data, and store the processed data in a designated address region of the working memory 265, again using the data bus 250 and memory controller 260. In this manner, for example, one or more drivers may be loaded by an operating system or hardware block.

Hence, the entirety of the memory space provided by the working memory 265 may be classified by defined region as either secure or non-secure. In this regard, the size, location and/or relationship of the regions may be defined, at least in part, by the functional attributes of the working memory 265, as well as by operation of the access control unit 240. Security contents may be stored in one or more secure region(s) of the working memory 265 (e.g.,) after being decoded.

The storage controller 270 may be used to control the operation of the external storage device 275. Here, the storage device 275 may store high-capacity user data such as image data or video data. The storage device 275 may be integrated in the mobile device 200, or may be implemented in a form that is detachable from the mobile device 200. The storage device 275 may be storage medium based on a flash memory.

The internal memory 280 is a memory disposed within the SoC 201 and may include a Static RAM (SRAM) or a Read Only Memory (ROM). Similarly to the working memory 265, the memory regions of the internal memory 280 and/or storage device 275 may be classified as secure or non-secure. The memory regions of the storage device 275 and internal memory 280 may also be defined in relation to their respective functional attributes, as well as by operation of the access control unit 240.

The hardware block 230 of the SoC 201 of FIG. 3 may share access to the external working memory 265, storage device 275, and/or internal memory 280 with other hardware blocks (not shown). Referring again to FIG. 2, for example, different masters including the hardware block 230 may share access to the working memory 265. This approach allows (e.g.,) the modem 120 to share external memory resources as well as various internal resources. It will be understood in this regard that the configuration illustrated in FIG. 3 is only one example of many different configurations consistent with the inventive concept that are capable of sharing external/internal resources. Such different configurations will vary according to the purpose of the SoC, as well as hardware and software resources provided by the SoC.

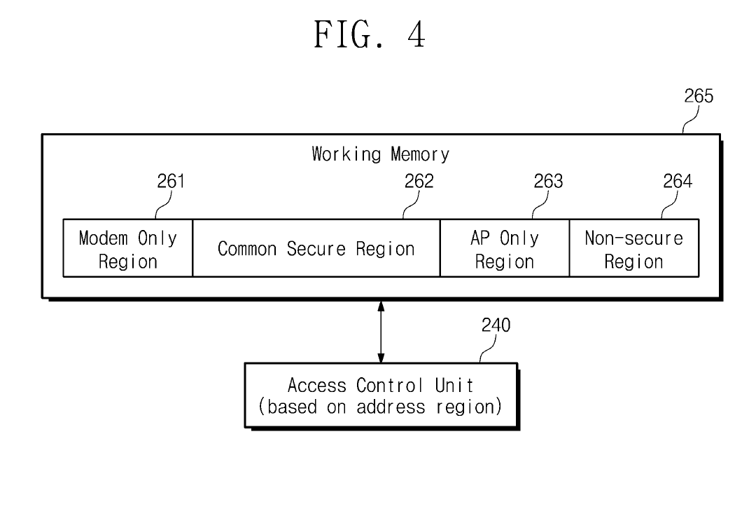

FIG. 4 is a block diagram further illustrating in one example an access control method that may be used with respect to the mobile device 200 of FIG. 3. Referring to FIGS. 2, 3 and 4, the access control unit 240 is assumed to control access to the working memory 265 based on address region(s).

For example, it is assumed that a first memory region of the working memory 265 is defined as a modem only region 261, a second memory region is defined as a common secure region 262, a third memory region is defined as an AP only region 263, and a fourth memory region is defined as a non-secure region 264. Here, it is further assumed that the common secure region 262 is a secure region and the other memory regions are non-secure regions.

With this configuration, it is still further assumed that the modem only region 261 may be exclusively used by the modem 120, and the AP only region 263 may be exclusively used by the AP 111, the common secure region 262 and non-secure region 264 may be shared by all of the masters.

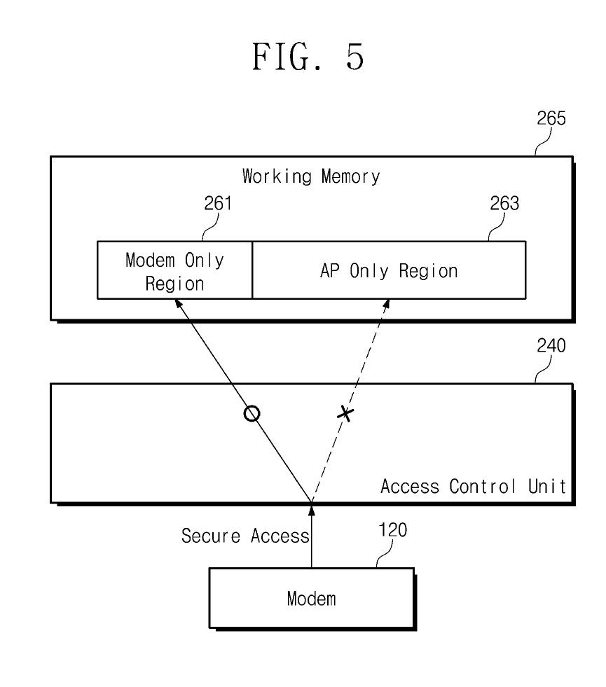

FIG. 5 is a conceptual diagram that further illustrates the access control method of FIG. 3, where access to the working memory 265 is based on defined address regions within the working memory 265.

Referring to FIGS. 2, 3, 4 and 5, the modem 120 (as one possible example of the hardware block 230 of FIG. 3) is assumed to access data stored in the working memory 265 through the access control unit 240. Even when the modem 120 is a secure master, the access control unit 240 may allow/disallow access to a particular memory region. For example, the access control unit 240 may allow access by the modem 120 to the modem only region 261, but disallow access to the AP only region 263.

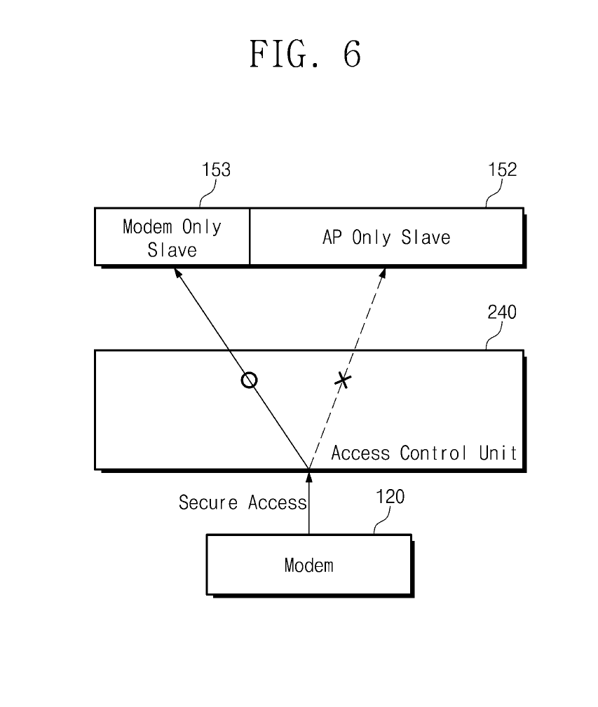

FIG. 6 is another conceptual diagram illustrating in the context of the embodiments illustrated in FIGS. 2 and 3, access by a master (e.g., modem 120 of FIG. 2) to a slave (e.g., modem only slave 153). Here, the access control method of FIG. 6 performs access control in relation to the slave based on address region.

Referring to FIG. 6, the modem 120 accesses a slave through the access control unit 240. Even when the modem 120 is a secure master, the access control unit 240 may allow/disallow access to a particular slave. For example, the access control unit 240 may allow secure access by the modem 120 to the modem only slave 251, but disallow access to the AP only slave 252.

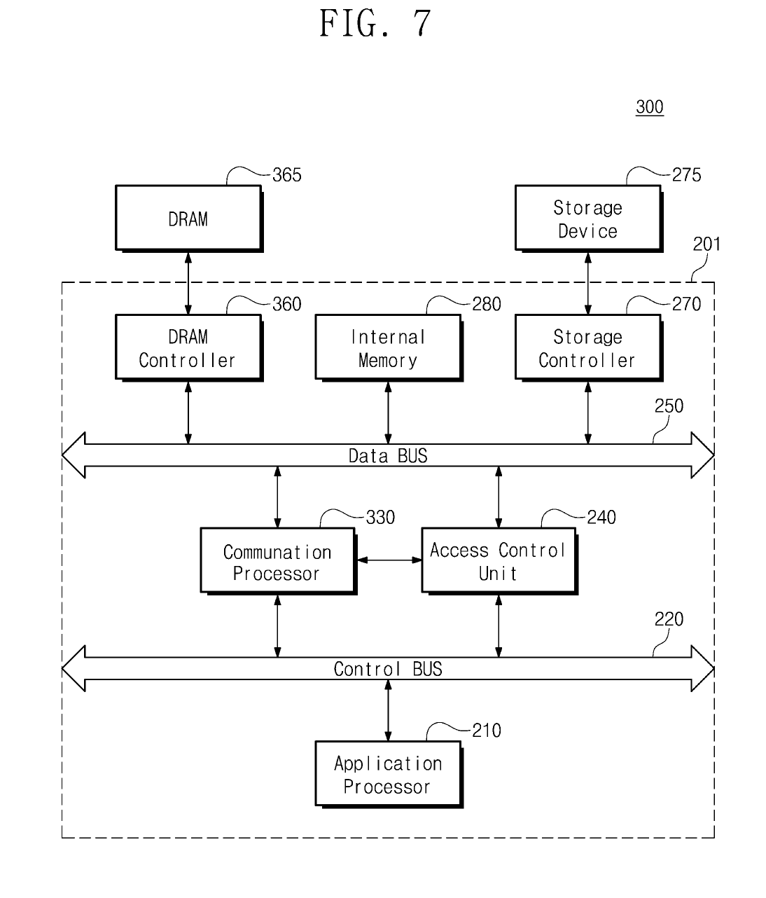

FIG. 7 is a block diagram illustrating a mobile device 300 according to another embodiment of the inventive concept. Comparing the mobile device 300 of FIG. 7 with the mobile device 200 of FIG. 3, the external working memory 265 is specifically replaced by a DRAM 365. Accordingly on the SoC 201, the memory controller 260 of FIG. 3 is replaced by a DRAM controller 360 of FIG. 7. Further, the general hardware block 230 of FIG. 3 is specifically replaced by a communication processor (CP) 330 of FIG. 7.

In this configuration, the SoC 201 more specifically includes both an application processor (AP) 210 and a communication processor (CP) 330. In certain embodiments, the CP 330 may be a modem. With this configuration, the AP 210 may be used to set the secure/non-secure mode of the CP 330, which functions as a hardware block (or system) connected to the AP 210 via the control bus 220. For example, the AP 210 may set the CP 330 as a secure master through the control bus 220. Assuming a configuration compatible with TrustZone, the AP 210 may set control units (e.g., TrustZone Protection Controllers (TZPC) and/or TrustZone Address Space Controller(s) (TZASC)) based on the nature of the content that will be processed and/or the nature of the system(s) used during the processing.

Here, for example, a TZPC is a control unit capable of setting secure attributes for one or more hardware blocks, where a TZPC may configure operation of the SoC 201 according to a TrustZone scheme by applying logical partitions by secure software and general software to periphery IPs. The secure attributes of the hardware blocks may be set to a secure mode or a non-secure mode through the TZPC.

A TZASC is a control unit capable of setting the secure attributes for a working memory, where the TZASC may configure (e.g., divide and define) attributes of different memory regions as secure or non-secure. Referencing FIG. 7, data stored in the DRAM 365 will include data that should be stored/managed in relation to a secure region, as well as data that should be stored/managed in relation to a non-secure region. In this regard, data corresponding to decoded security contents may be stored/managed in the secure region by a TZASC. Further, one or more translation table(s) that define various access paths for the access control unit 240 may be stored/managed in relation to a secure region of the DRAM 365.

In the configuration illustrated in FIG. 7, the access control unit 240 may be used to control access to slaves and/or memory regions by the CP 330. Similarly, assuming that the CP 330 is a Wi-Fi system (or a GNSS), the access control unit 240 is functionally situated between the Wi-Fi system and the data bus 250, thereby controlling access by the Wi-Fi system. In this manner, the access control unit 240 may individually manage the access control operations of various hardware blocks, or integrate several hardware blocks to collectively manage the hardware blocks.

The data bus 250 provides a memory access path for the AP 210 and/or CP 330. Thus, access to the internal memory 280, external DRAM 365 and/or external storage device 275 may be made through the data bus 250.

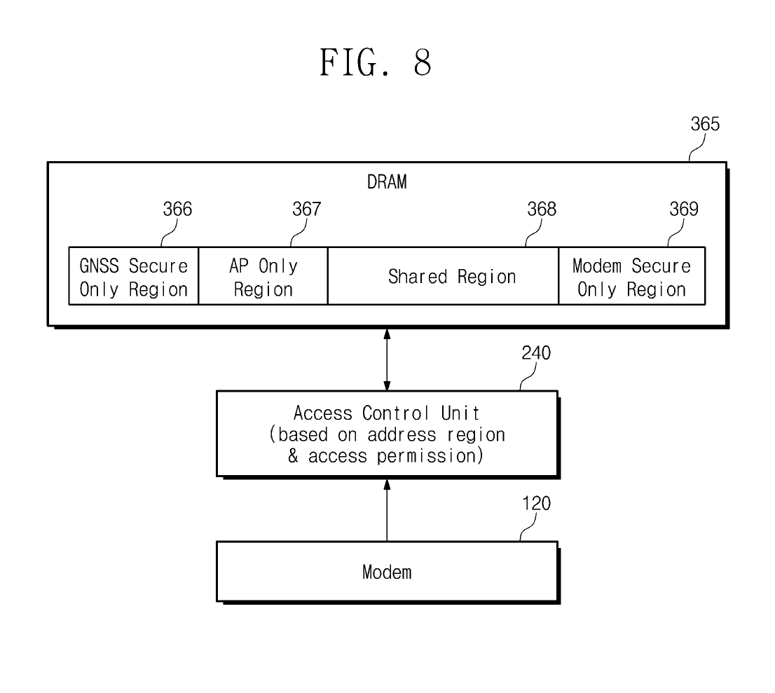

FIG. 8 is a block diagram illustrating the access control method that may be used in relation to the SoC 201 of FIG. 7. Referring to FIG. 8, the modem 120 may access the DRAM 365 via the data bus 250 and DRAM controller 360 under the control of the access control unit 240. Here again, the access control unit 240 may control access to a slave or memory resource (internal or external) based on address region and/or access permission.

For example, a first memory region of the DRAM 365 may be defined as a GNSS secure only region 366, a second memory region may be defined as an AP only region 367, a third memory region may be defined as a shared region 368, and a fourth memory region may be defined as a modem secure only region 369. Here, a secure master may access a secure region. Non-secure masters as well as the secure master may access a non-secure region.

The GNSS secure only region 366 is a secure region and may be accessed when the GNSS is a secure master. Even when the modem 120 is a secure master, the modem 120 cannot access the GNSS secure only region 366. The AP only region 367 is a non-secure region and may accessed only by the AP 210. The shared region 368 is a non-secure region, and may be accessed by all the masters. The modem secure only region 369 is a secure region, and may be accessed when the modem 120 is a secure master.

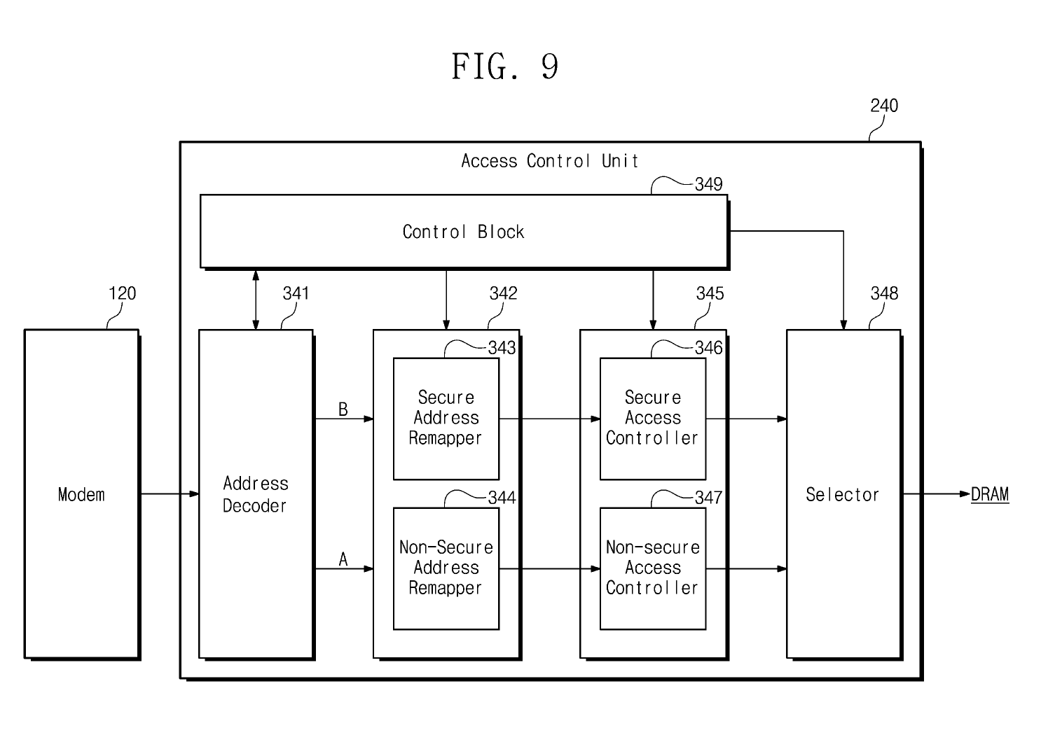

FIG. 9 is a block diagram illustrating in one example the access control unit 240 of FIGS. 3 through 8, inclusive. As previously described, the access control unit 240 may control access to a slave and/or a memory resource (internal or external) by a hardware clock (e.g., modem 120) based on address region and/or access permission.

Referring to FIG. 9, the access control unit 240 includes an address decoder 341, an address remapper 342, an access controller 345, a selector 348, and a control unit 349. The access control unit 240 may perform an access control for the memory region of the DRAM 365 based on an address region provided by the modem 120 and secure attribute(s) of the modem 120.

The address decoder 341 receives an address of the DRAM 365, which the modem 120 attempts to access, and determines whether the received address corresponds to a secure region or a non-secure region. In the case of a non-secure region, a non-secure access control operation is performed through path A. In the case of a secure region, a secure access control operation is performed through path B.

The address remapper 342 includes a secure address remapper 343 and a non-secure address remapper 344. The address remapper 342 may include an address mapping table for mapping a virtual address to a physical address. The address remapper 342 may map a virtual address output from the modem 120 to a physical address of the DRAM 365.

Even though the AP 210 accesses the modem 120 while being a non-secure master, during operation of a general operating system, a site which a secure transaction of the modem 120 may actually access is limited to a memory region mapped by the address remapper 342. Accordingly, an access by the modem 120 may be disallowed by defining a translation table of the address remapper 342. Here, the translation table of the address remapper 342 may be managed in a secure region of the DRAM 365.

The access controller 345 may disallow access by the modem 120 based on the address region and the access permission of the modem 120. The access controller 345 is controlled by the control unit 349. The access controller 345 includes a secure access controller 346 and a non-secure access controller 347. When the modem 120 corresponds to a secure access, the secure access controller 346 may disallow secure access of another system (for example, the GNSS) other than the modem 120.

The selector 348 may receive an address region which the modem 120 intends to access from an address decoder 341 or the control unit 349. The selector 348 may selectively provide any one of a secure access control operation and a non-secure access control operation of the modem 120. The control unit 349 may control operations of the address decoder 341, the address remapper 342, the access controller 345, and the selector 348.

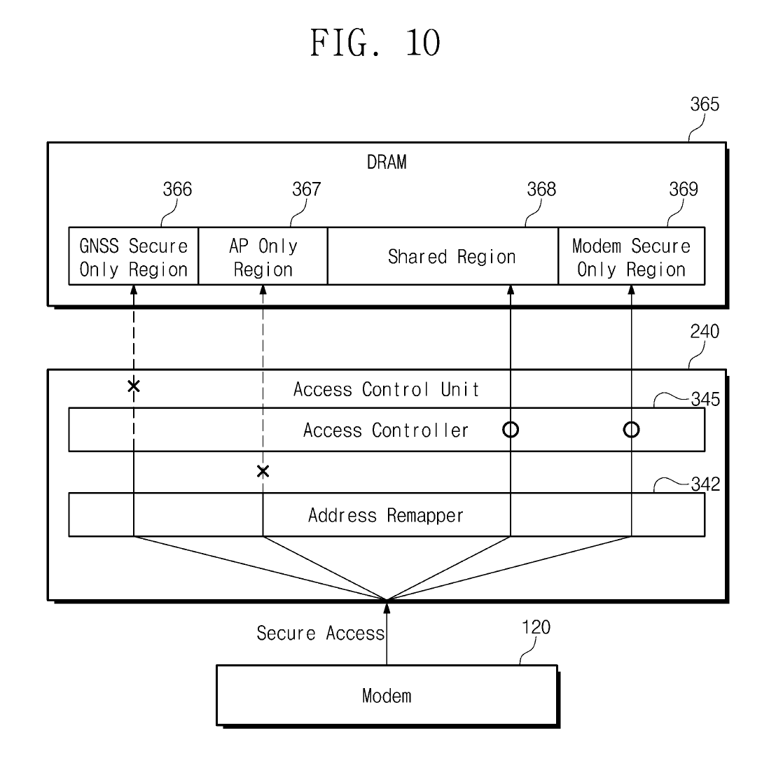

FIG. 10 is a conceptual diagram illustrating an operating method for the access control unit 240 of FIGS. 3, 7 and 9. In FIG. 10, it is assumed that the modem 120 performs a secure access. When the modem 120 is a secure master, a secure access operation is performed via path B of FIG. 9.

Referring to FIG. 10, the modem 120 may access the memory region of the DRAM 365 under the control of the access control unit 240. For example, the memory region of the DRAM 365 may include a GNSS secure only region 366, an AP only region 367, a shared region 368, and a modem secure only region 369. Here, because the modem 120 is a secure master, it may access the non-secure region and the secure region of the DRAM 365.

However, the GNSS secure only region 366 is a secure region, and may be accessed only by the GNSS. Accordingly, even when the modem 120 is a secure master, the modem 120 cannot access the GNSS secure only region 366. When the modem 120 attempts to access the GNSS secure only region 366, the access control unit 240 disallows access. For example, the access control unit 240 may disallow access by the modem 120 using the secure access controller 346.

The AP only region 367 is a non-secure region and may be accessed only by the AP. Therefore, the access control unit 240 will disallow an access attempt by the modem 120 to the AP only region 367. For example, the access control unit 240 may disallow access by the modem 120 using the secure address remapper 343, or the secure access controller 346.

The shared region 368 is a non-secure region and may be accessed by all masters. Accordingly, the modem 120 may access the shared region 368. The modem secure only region 369 is a secure region, and may be accessed by the modem 120 because the modem 120 is the secure master.

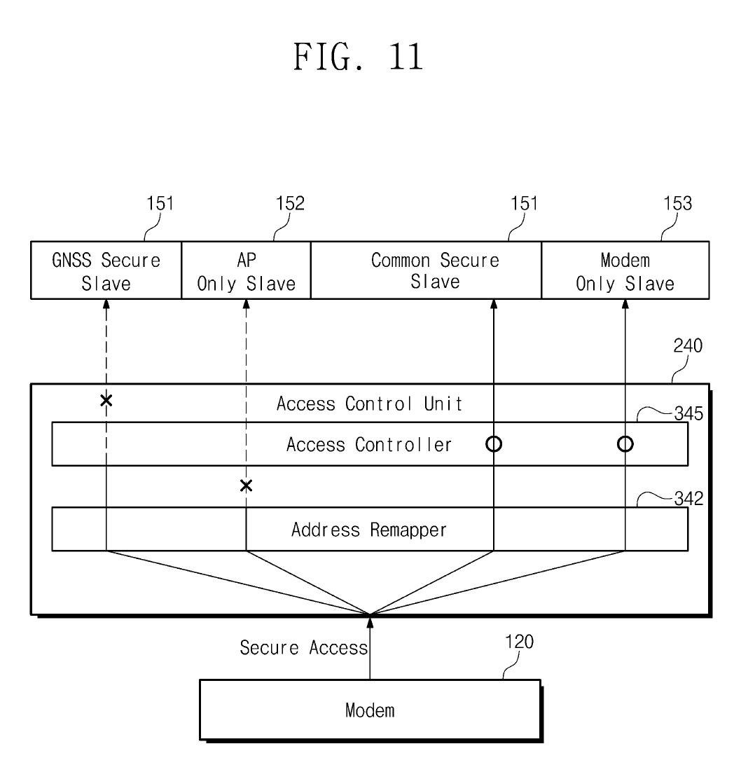

FIG. 11 is another conceptual diagram illustrating an operating method for the access control unit 240 of FIGS. 3, 7 and 9. In FIG. 11, it is again assumed that the modem 120 performs a secure access. When the modem 120 is a secure master, a secure access operation is performed through path B of FIG. 9.

Referring to FIGS. 2 and 11, the modem 120 may access slaves under the control of the access control unit 240. Slaves may include the GNSS secure slave 151, AP only slave 152, common secure slave 151, and modem only slave 153. Because the modem 120 is a secure master, it may access a secure slave and a non-secure slave.

However, the GNSS secure slave 151 is a secure slave and may be accessed by only the GNSS. Accordingly, even when the modem 120 is a secure master, the modem 120 may not access the GNSS secure slave 151. When the modem 120 attempts to access the GNSS secure slave 151, the access control unit 240 disallows the access. For example, the access control unit 240 may disallow access by the modem 120 using the secure access controller 346.

The AP only slave 152 is a non-secure slave and may be accessed by only the AP. Hence, the access control unit 240 will disallow access by the modem 120 to the AP only slave 152 using, for example, the secure address remapper 343 or the secure access controller 346.

The common secure slave 151 is a secure slave and may be accessed by all masters. Accordingly, the modem 120 may access the common secure slave 151. The modem only slave 153 is a non-secure slave and the modem 120 may access the modem only slave 153.

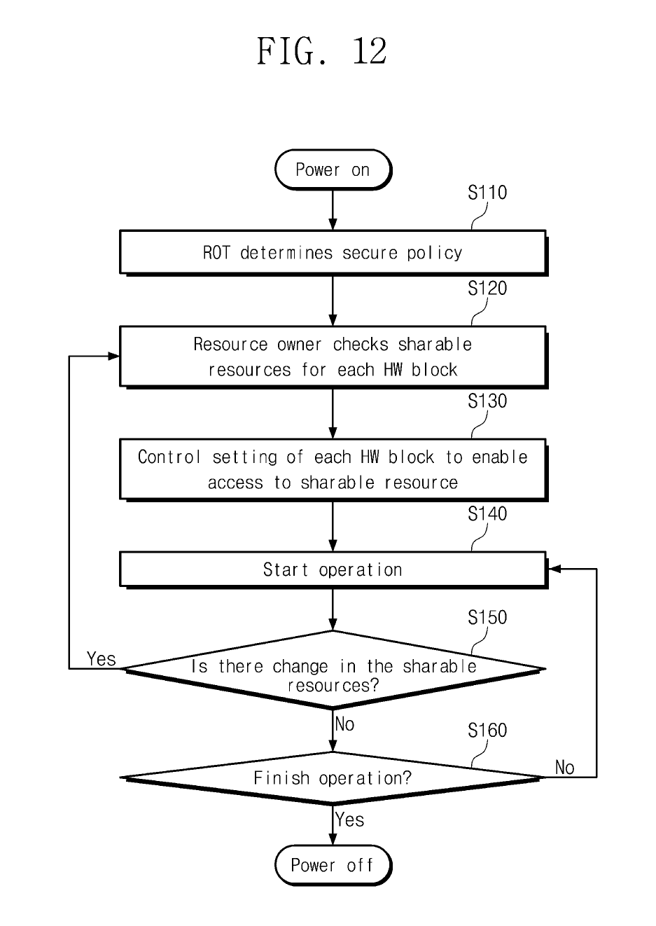

FIG. 12 is a flowchart illustrating an access control operation for the mobile device 200 of FIG. 3 or mobile device 300 of FIG. 7. When the mobile device 200/300 is powered ON, an operating system boot operation is performed, and a secure operating system is prepared.

Following power-on, a Root-of-Trust (ROT) determines a secure policy for the mobile device 200/300 (S110). Thereafter, the access control unit 240 determines whether an access is a secure access or a non-secure access based on the determined secure policy.

A resource owner may check sharable resources for each hardware block integrated within a SoC (S120). Here, the resource owner may be the ROT or a designated secure master, where the designated secure master may obtain information associated with one or more access permission(s) from the ROT.

Generally speaking, non-secure masters may set non-secure resources. And even when a resource owner is a non-secure master, an access permission may be provided to the non-secure master when an ROT is additionally necessary.

Next, a control setting for each hardware block is performed to enable access to one or more sharable resource(s) (S130). Then when each hardware block is started (S140) a determination may be made as to whether or not a change in sharable resources should be made. When no change in sharable resources is required (S150=No), the operation is finished (e.g., the mobile device is powered OFF) (S160). Otherwise, if a change in sharable resources is required (S150=Yes), the method returns to step 120.

According to the foregoing, a SoC according to embodiments of the inventive concept may control access operations by respective hardware blocks (systems) using an access control unit, where access control operations may be performed according to secure attributes and access permissions associated with the systems. When various systems are integrated onto the SoC—even systems provided by different vendors—embodiments of the inventive concept provide a method and an apparatus for flexibly enabling access with reduced potential for security problems.

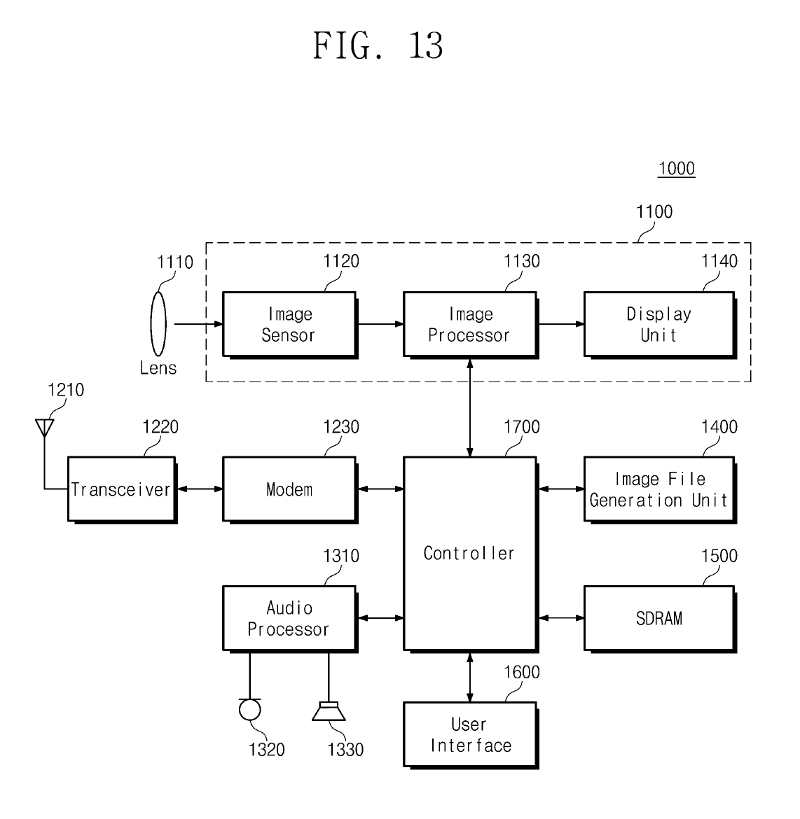

FIG. 13 is a block diagram illustrating a mobile device 1000 including a SoC according to an embodiment of the inventive concept. Referring to FIG. 13, the mobile device (e.g., a portable terminal) 1000 includes an image processing unit 1100, a radio transceiver unit 1200, an audio processing unit 1300, an image file generation unit 1400, an SRAM 1500, a user interface 1600, and a controller 1700.

The image processing unit 1100 includes a lens 1110, an image sensor 1120, an image processor 1130, and a display unit 1140. The radio transceiver unit 1200 includes an antenna 1210, a transceiver 1220, and a modem 1230. The audio processing unit 1300 includes an audio processor 1310, a microphone 1320, and a speaker 1330. The portable terminal 1000 may be provided with various kinds of semiconductor devices. In particular, a system-on-chip that performs a function of the controller 1700 requires low power consumption and high performance.

Although detailed embodiments of inventive concepts have been described, it should be understood that numerous other modifications, changes, variations, and substitutions can be devised by those skilled in the art. Moreover, it should be understood that the inventive concepts cover various techniques which can be readily modified and embodied based on the above-described embodiments

What is claimed is:

1. A system comprising:
a System-on-Chip (SoC) comprising:
a hardware block configured between a control bus and a data bus;
a processing unit configured to set the hardware block in one of a secure mode and a non-secure mode via the control bus; and
an access control unit configured to control access by the hardware block to memory resources via the data bus based on an address region and a secure attribute of the hardware block,
wherein the memory resources include an internal memory, an external working memory and a storage device, and the address region indicates a memory region of one of the memory resources.

2. The system of claim 1, wherein the hardware block is a communication processor (CP), the processing unit is an application processor (AP), and the working memory is a DRAM including secure regions and non-secure regions.

3. The system of claim 2, wherein the SoC further comprises:
a memory controller connected between the DRAM and the data bus and configured to control the DRAM,
wherein the address region indicates one of the secure regions or one of the non-secure regions of the DRAM.

4. The system of claim 2, wherein the access control unit is further configured to control access by the CP to the DRAM via the data bus based on a secure attribute of the CP.

5. The system of claim 3, wherein the address region corresponds to a virtual address provided by the CP, and the access control unit comprises an address decoder configured to receive the address region and determine whether a memory region of the DRAM indicated by the address region is a secure region or a non-secure region.

6. The system of claim 2, wherein the SoC further comprises:
a storage controller connected between the storage device and the data bus and configured to control the storage device including secure regions and non-secure regions,
wherein the address region indicates one of the secure regions or one of the non-secure regions of the storage device.

7. The system of claim 6, wherein the address region corresponds to a virtual address provided by the CP, and the access control unit comprises:
an address decoder configured to receive the address region and determine whether a memory region of the storage device indicated by the address region is a secure region or a non-secure region; and
an address remapper configured to map the virtual address to a physical address of the storage device.

8. The system of claim 7, wherein the address remapper comprises:
a translation table configured to map the virtual address to the physical address.

9. The system of claim 8, wherein the access control unit further comprises:
an access controller configured to disallow access by the CP to the storage device based on the address region and an access permission of the CP.

10. A System-on-Chip (SoC) configured to operate with an external working memory and a storage device, the SoC comprising:
an internal memory;
a plurality of masters including an application processor (AP) and a communication processor (CP) connected via a bus to a plurality of slaves; and
an access control unit that controls access to the internal memory, working memory and storage device by at least one of the masters, based on an address region and an access permission of the CP,
wherein each master is capable of operating in a secure mode and a non-secure mode as determined by the AP,
the bus comprises a control bus and a data bus,
the CP is disposed between the control bus and the data bus, and
the access control unit is functionally disposed between the CP and the internal memory, the working memory and the storage device.

11. The SoC of claim 10, wherein the plurality of slaves comprises a common secure slave accessed by all secure masters, a common slave accessed by all masters, an AP only slave accessed by only the AP, and a CP only slave accessed by only the CP.

12. The SoC of claim 11, wherein the access control unit controls access to the internal memory, working memory and storage device by the CP based on an address region provided by the CP.

13. A mobile device comprising:
a System-on-Chip (SoC) comprising a plurality of processors; and
a memory device connected to the SoC,
wherein the SoC comprises an access control unit that comprises first and second processors, the first processor setting a secure mode of the second processor via a control bus and setting an access control of the second processor based on an address region and an access permission of the second processor.

14. The mobile device of claim 13, wherein the first processor is an application processor and the second processor is a communication processor.

15. The mobile device of claim 13, wherein the access control unit performs an access control about a memory region of the memory device, based on an address provided from the second processor and a secure attribute of the second processor.

16. The mobile device of claim 15, wherein the access control unit comprises:
an address decoder configured to receive an address of the memory device which the second processor intends to access, and determine whether the memory region of the memory device is a secure region or a non-secure region;
an address remapper configured to map a virtual address provided from the second processor to a physical address of the memory device; and
an access controller configured to disallow access by the second processor to the memory device, based on an address region and an access permission of the second processor.

17. The mobile device of claim 16, further comprising:
a third processor, wherein when the second processor is a secure master, the access controller disallows access by the second processor to a secure region of the third processor pertaining to a secure region of the external memory.

18. The mobile device of claim 15, further comprising:
one or more slaves for operations of the first and second processors,
wherein the access control unit performs an access control about the slaves, based on an address provided from the second processor and a secure attribute of the second processor.

19. The mobile device of claim 18, wherein the access control unit comprises:
an address decoder configured to receive an address of a slave which the second processor attempts to access, and determine whether the slave is a secure slave or a non-secure slave; and
an access controller configured to disallow access by the second processor to a specific slave based on an address region and an access permission of the second processor.

20. The mobile device of claim 19, further comprising:
a third processor, wherein when the second processor is a secure master, the access controller disallows access by the second processor to a slave only for the first processor among the one or more slaves.
